(19) United States
(12) Patent Application Publication
(10) Pub. No.: US 2007/0271238 A1
(43) Pub. Date: Nov. 22, 2007

(54) System and Method For Improving the Search Visibility of a Web Page

(76) Inventors: Jeffrey Webster, Phoenix, AZ (US); Anthony James Wasson, Phoenix, AZ (US); Narayanan Ramamrutham, Peoria, AZ (US); Todd Kurtz, Phoenix, AZ (US); Guljot Grover, Scottsdale, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/615,330

(22) Filed: Dec. 22, 2006

Related U.S. Application Data
(60) Provisional application No. 60/800,974, filed on May 17, 2006.

(51) Int. Cl. G06F 17/30

(52) U.S. Cl. 707/3

(57) ABSTRACT

A system and method for updating a web page to improve search visibility. In one aspect, a web page is updated by refreshing the web page using values obtained from a database, wherein the values have been selected to improve the search visibility of the web page. The values may be search engine optimized HTML code delivered to a web server from an external database server. In another aspect, a request is received for a web page, and in response to the request, an alternate web page is sent. The alternative web page corresponds to the requested web page, but further has content (e.g., search-optimized meta data) to improve the search visibility of the requested web page.

### RELATED APPLICATIONS

This application claims priority to Provisional Application No. 60/800,974 filed May 17, 2006 (titled SYSTEM AND METHOD FOR UPDATING A WEB PAGE TO IMPROVE SEARCH VISIBILITY by Jeff Webster et al.), the contents of which are incorporated herein by reference in their entirety.

### BACKGROUND

1. Field

The present disclosure relates in general to online publication, and more particularly to a system and method for improving the online search visibility of a published web page and optionally tracking requests for the web page.

2. General Background

Online publication (e.g., online stores and advertising) generally refers to publication (e.g., serving of web pages) on the Internet. Online stores and advertising are sources of revenue for an increasing number of companies. For example, Google receives revenue from the placement of advertisements in search results generated for online users, and eBay receives revenue from creating a online marketplace for the sale of goods.

Online visitors to websites on the Internet may be directed to a company's website in several ways including, for example, paid-for advertisements that link to a merchant's website or links presented in the natural search results presented by a search engine (e.g., Yahoo!, MSN, or Google) in response to a visitor's language query.

It is usually desirable that a web page have good, visibility to search engines (e.g., higher relevancy to search engines). This is particularly true for online stores and other websites selling products or services. Page visibility is typically improved using natural search engine optimization (NSO), and NSO is usually done using manual techniques.

As the contents of the web page are changed (e.g., due to adding new items to a store catalog), the prior NSO becomes somewhat outdated. Yet, performing manual NSO repeatedly in order to keep up with page content changes is not practical, and website operators typically fail to routinely update the NSO for the pages on a website with regularly changing content.

More specifically, NSO, or alternatively search engine optimization (SEO), typically refers to a set of approaches used to improve the ranking of a website in search engine listings (e.g., such as in Google search results). Typically, NSO has the goal of improving the visibility of a merchant or other company's website in natural search results. A merchant's desired search visibility goal will vary depending on the type of web traffic the merchant is seeking. For example, a merchant may desire to target a specific population with certain needs or interests. Such a merchant typically attempts to optimize its website for keywords likely to be used by the desired potential customer in requesting a keyword search from a search engine.

Natural search results attract the majority of Internet search click-throughs (e.g., up to 80%), depending on the applicable vertical market and the type of search. There are billions of web pages that exist on the Internet; only a small percentage will appear on the first page of the natural search results. Those that do typically make the most qualified connection with the desired target audience for a merchant or company's website and outrank or have improved search visibility as compared to their competition. NSO helps to ensure that web content achieves the maximum visibility for its most relevant keywords and phrases across the leading search engines. Natural search results appear as the main body of listings in major search engines, typically distinct from the advertising that is labeled as “paid,” “featured,” or “sponsored.” Search engines create natural results by crawling the web, sending “spiders” out to follow the billions of links on the Internet and find new and updated pages.

NSO improves the ability of online content (e.g., Adobe PDF files, Flash files, news releases, or product descriptions) to be crawled, indexed, and ranked by search engines. An NSO service provider or agency typically provides strategic recommendations to ensure that spiders find and read optimized content for search visibility. By managing, analyzing, and reporting on the performance of a website's visibility and providing ongoing recommendations, the service provider typically enhances the quality and quantity of a business's online traffic.

Businesses that advertise typically desire information about the return on investment (ROI) that is achieved by the advertising. Working with an NSO agency helps to ensure that all web content on a website has been optimized for improved exposure and ROI. The search engine landscape changes constantly, and competitors vie to attract the same level of visibility. Also, search engines regularly rework the factors and methods used to rank web pages. Further, businesses often change their business objectives and messaging (e.g., as a business evolves or product or service markets change). To account for the foregoing dynamic conditions, businesses often routinely need to update the NSO of their websites to reflect recent changes in the natural search engine results. However, as mentioned above, such updating is typically manually intensive and thus not done, or only done infrequently.

In light of the above, it would be desirable to have an improved system and method to routinely perform NSO updating of the pages on a website.

### BRIEF DESCRIPTION OF THE DRAWINGS

For a more complete understanding of the present disclosure, reference is now made to the following figure, wherein like reference numbers refer to similar items:

FIG. 1 is a functional block diagram illustrating a system for updating web page search visibility in accordance with one embodiment.

The exemplification set out herein illustrates particular embodiments, and such exemplification is not intended to be construed as limiting in any manner.

### DETAILED DESCRIPTION OF THE DISCLOSURE

The following description and the drawing illustrate specific embodiments sufficiently to enable those skilled in the art to practice the system and method described. Other embodiments may incorporate structural, logical, process and other changes. Examples merely typify possible variations. Individual components and functions are optional unless explicitly required, and the sequence of operations may vary. Portions and features of some embodiments may be included in or substituted for those of others.

The elements that implement the various embodiments of the present system and method are described below, in some cases at an architectural level. Many elements may be configured using well-known structures.

The processing described below may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any type of memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including existing memory technologies as well as hardware or circuit representations of such structures and of such data.

It should also be understood that the techniques of the present system and method might be implemented using a variety of technologies. For example, the methods described herein may be implemented in software running on a programmable microprocessor, or implemented in hardware utilizing either a combination of microprocessors or other specially designed application specific integrated circuits, programmable logic devices, or various combinations thereof. In particular, the methods described herein may be implemented by a series of computer-executable instructions residing on a storage medium such as a carrier wave, disk drive, or other computer-readable medium.

As used herein, the term “entity” refers to an individual, corporation, partnership, or other type of legal entity.

A system and method for updating a web page for improved search visibility are described below. In one aspect, the method comprises updating a web page by refreshing at least a portion of the web page using values obtained from a database, wherein the values have been selected to improve the search visibility of the web page. For example, the values may be search engine optimized HTML code delivered to a web server from an external database server operated by an NSO entity. Alternatively, the values may be obtained from a database maintained on or accessible via a local network from the web server.

When building a web page, certain elements of the page are typically provided from a database. The web server on which the page is running requests these elements when rendering the page (e.g., to a browser). These elements may include text and/or graphics (e.g., images and descriptions of products for sale in an online catalog).

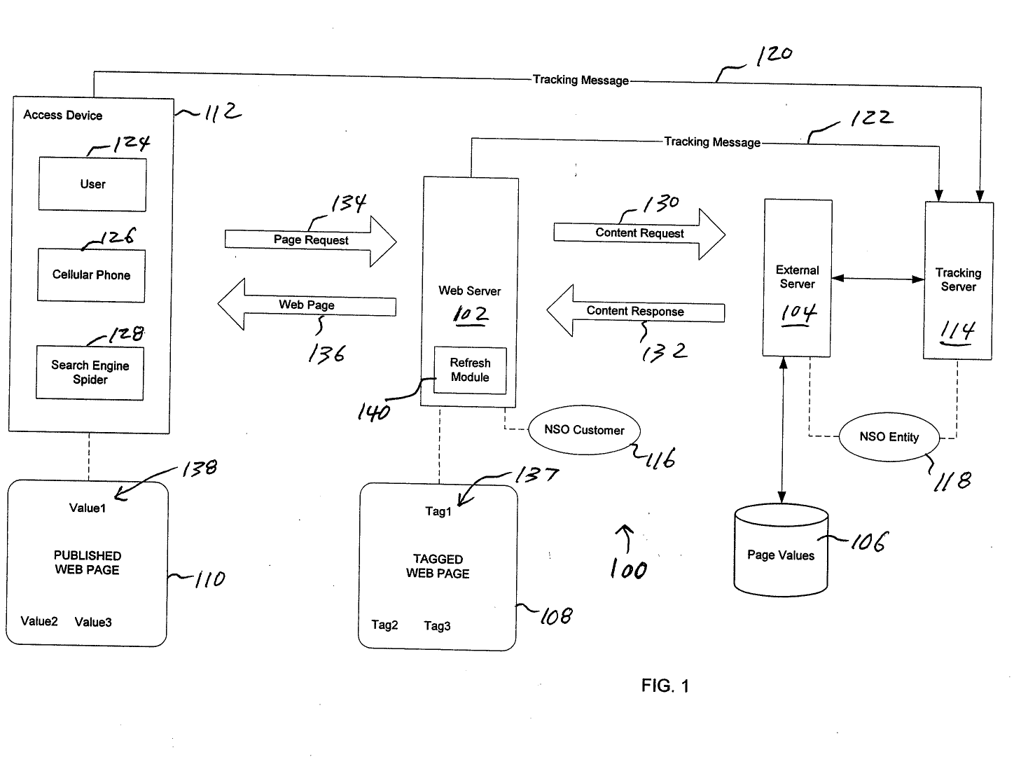

FIG. 1 is a functional block diagram illustrating a system for updating the search visibility of a web page. Specifically, an updating system 100 comprises a web server 102 in communication with a database 106 (e.g., over an Internet or wide area network connection). Web server 102 runs or serves web pages (e.g., web page 136) in response to requests made (e.g., page request 134) from an access device 112 (e.g., over the Internet). A web page 108 to be rendered by web server 102 may contain tags 137 (indicated as Tag1, Tag2, etc.) to be substituted with page values 138 from a database 106 as part of the rendering process, as is described in more detail below. For example, as illustrated in FIG. 1, Value1 would be substituted for Tag1, Value 2 for Tag2, and Value 3 for Tag 3.

In one example, web server 102 may be owned or operated by an NSO customer 116. External server 104 may be owned or operated by an NSO entity 118. In some cases, NSO entity 118 is engaged by NSO customer 116 to perform NSO for the customer's website. The system and method herein improve the ability to make regular NSO updates to the website. NSO customer 116 may be, for example, a publisher or a syndication host, or may make frequent (e.g., daily) re-designs to its website (even if such re-designs are minor).

More specifically, the ability to perform NSO content updating or other updating of web pages (e.g., web page 108) served by web server 102 (e.g., on a website of NSO customer 116) may be automated by embedding tags 137 into the web page. Tagged web pages 108 run on web server 102. Each tagged web page 108 contains tags 137, which are inserted into web page 108 to enable later tag substitution with values obtained from database 106. Tags 137 may be, for example, inserted by an NSO entity 118 when initially engaged by NSO customer 116 to perform NSO for a website running on web server 102.

When web page 108 is rendered by web server 102 in a request from an access device 112, tags 137 are substituted with values 138 (obtained from database 106) to provide published web page 110. Access device 112 may include, for example, an Internet browser executed by a user 124 on a personal computer (not shown) or a cellular phone 126, or a search engine 128 (e.g., spider or webcrawler).

Tags 137 may be, for example, XML or HTML tags. Tags 137 may be associated with or placed on elements of web page 108 such as the title, meta keywords, and other specific content. The presence of tags 137 typically will not change the page rendering to a browser, or spider or webcrawler (i.e., the page will appear to be the same as if no tags 137 were initially present).

It should be noted that tags 137 in web page 108 may be, for example, pieces of content that may be used by refresh module 140 to match certain textual patterns against, and subsequently to take appropriate action if the pattern is matched. For example, this action may be to replace the pattern with optimized content authored by NSO Entity 118. When using this approach, the value of the tags may be either the same or different for different pages in a web site (e.g., a web site of NSO customer 116).

The web pages 108 for which tags 137 may be used include, for example, ASP, JSP and .Net pages. Also, the updating method described herein may be used, for example, with raw static pages using Server Side Includes (SSI) technology. As is known, SSI (Server Side Includes) are directives that are placed in HTML pages, and evaluated on the server while the pages are being served. SSI permits adding dynamically generated content to an existing HTML page, without having to serve the entire page via a CGI program, or other dynamic technology. The updating may also be implemented by putting hooks (e.g., operating system hooks) in the software executing on web server 102 so that when any web page 108 is processed for rendering, it is run, for example, through a refresh module 140 (discussed below) or other module as part of the processing.

Values 138 may be, for example, search engine optimized HTML code or other text, graphics code, etc., customized or otherwise selected for or corresponding to the web page 108. For example, a tag 137 named “Page Title” may be substituted with the text value “Welcome to My Page”.

As another example, a tag 137 named “Advertisement No. 1” may be substituted with an advertisement being published by NSO entity 118. This advertisement could be pulled by external server 104 from yet another external ad server or servers (not shown).

NSO entity 118 may, for example, update database periodically with values 138 that are NSO content updates designed to improve search visibility. In other words, when web page 108 is rendered using values from database 106, the NSO for the page is updated, which typically improves search engine visibility for a web page with regularly changing content. An example of a web page with regularly changing content is a web page advertising products and prices in an online store catalog.

Database 106 may run on external server 104. In alternative embodiments, database 106 may run on web server 102. For example, NSO entity 118 may have electronic or other access to web server 102 for periodic updating of values 138.

Web server 102 may comprise a software refresh module 140 (e.g., software code executing on web server 102) for requesting page values 138 from database 106. For example, web server may make a content request 130 for web page updates to external server 104. Communication between web server 102 and external server 104 may be implemented, for example, using a Simple Object Access Protocol (SOAP) interface for both dynamic and real-time interfaces.

Content request 130 identifies the tags 137 in the web page 108 to be rendered. In content response 132, external server 104 provides values 138 corresponding to the identified tags 137. The retrieved values 138 may be stored in a local database (not shown) accessible by web server 102 for rendering web pages 108 when values 138 will not be updated prior to rendering the web page (e.g., following an updating done for the prior request received a few minutes earlier).

In an alternative embodiment, refresh module 140 may be used to redirect page requests 134 for web page 108 to a different location, for example, on web server 102. This location will have search-optimized content, for example, authored by NSO entity 118. The search-optimized content may be provided, for example, from database 106. The content may be, for example, meta data and/or text that is visible on a user device that has requested web page 108. For any given page request, if the different location does not have optimized content for web page 108, module 140 may direct the request 134 to be served from the location originally encapsulated in the request. The requested page location and the different location may be, for example, URLs pointing to memory and/or a file system located on web server 102. In this alternative embodiment, web page 108 may be used with or without tags 137. The different location for serving the web page may optionally be, for example, external server 104 or another server (not shown).

Refresh module 140 may determine the type of access device 112 making a page request (e.g., whether it is a cellular phone or a personal computer). The values 138 may be selected from database 106 based on the type of access device. The device type may be passed to external server 104 as part of content request 130.

The updating of web page 108 with values 138 may be done, for example, every time the page is rendered by web server 102. Other examples include updating with new values 138 after a fixed number of user 124 or search engine 128 requests for the page 108 have been made. Another exemplary alternative is to update once every given time interval (e.g., every 30 seconds). Refresh module 140 may be coded to implement the foregoing updating cycles.

Optionally, requests made for web page 108 by an access device 112 may be tracked, for example, by the sending of a tracking message 120 from the access device 112 to a tracking server 114. NSO entity 118 may, for example, own or operate tracking server 114. The tracking messages 120 may be used to provide tracking reports. Tracking server 114 may also communicate with external server 104.

As an alternative way to track requests made for web page 108, web server 102 may send a tracking message 122 to tracking server 114 when web page 108 is updated using one or more values 138 obtained from database 106. This may permit, for example, tracking of visits to the web page by users 124. The sending of tracking message 122 may be, for example, initiated upon the event of the substitution of one or more tags 137 with one or more of values 138 obtained from database 106.

It should be noted that when a user 124 is, for example, accessing the web page 108 using a browser, the sending of tracking message 122 is not dependent upon the prior receipt of any tracking message from the browser. In other words, tracking message 122 can be sent without regard to transmission bandwidth or browser controls or other limitations associated with awaiting a receipt of a message from the browser in order to track visits to web page 108.

In other embodiments, one of tags 137 may be used to dynamically refresh the updating intelligence (e.g., modifying a portion of the software code of refresh module 140) running on web server 102. The refreshed software code may be reported back to tracking server 114 by web server 102. Also, the web page updating period (as was described above) may itself be updated by substitution of a tag 137 using a value from database 106. For example, a refresh cycle value of 5 (i.e., updating the web page 108 on every fifth access device request) may be updated to a new value 138 provided from external server 104. Further, this value 138 may be selected under the control or operation of NSO entity 118 and correspond to improving search visibility of web page 108 on a real-time or dynamic basis. Finally, it should be noted that although search-optimized content or other values described above typically will be periodically updated, in other embodiments this updating may only be done one time.

### System Implementation

The system and method for updating a web page described above generally may be implemented using conventional hardware and network communication components and software programming techniques and languages. Examples of online system components that may be used are described in U.S. Patent Application Publication No. US 2005/0149396 A1 (titled ONLINE ADVERTISING SYSTEM AND METHOD by Horowitz et al. and published Jul. 7, 2005) and U.S. Patent Application Publication No. US 2005/0216335 A1 (titled SYSTEM AND METHOD FOR PROVIDING ON-LINE USER-ASSISTED WEB-BASED ADVERTISING by Fikes et al. and published Sep. 29, 2005), each of which is incorporated herein by reference.

All or portions of updating system 100 may run in a secure data center and may be provided as a web or local service to NSO customers 116 by NSO entity 118. Updating system 100 may, for example, be developed using a distributed, component-based architecture that can be scaled to accommodate a large number of sessions per day.

The software of the updating system 100 may be executed on one or more servers. The servers may communicate over a communication network with client devices such as, for example, a personal computer or PDA. The communication networks may be, for example, the Internet, a mobile phone network, or a local or wide area network. The servers of updating system 100 may execute various modules of software to implement one or more of the functions described above. The software modules that may be executed by the updating system 100 may, for example, be distributed across multiple servers.

### CONCLUSION

By the foregoing description, an improved system and method for updating the online search visibility of a published web page and optionally tracking requests for the web page have been described. The improved system and method may be substantially or completely web-based such that the user and/or NSO customer may access the updating system 100 (e.g., for viewing web pages or management of customer account functions) from many computers (e.g., any network device providing, for example, Internet browsing capabilities).

The foregoing description of specific embodiments reveals the general nature of the disclosure sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation.

What is claimed is:

1. A method comprising updating a web page by refreshing at least a portion of the web page using values obtained from a database, wherein the values have been selected to improve the search visibility of the web page.

2. The method of claim 1 further comprising determining, prior to updating the web page, the type of device requesting the web page; and wherein updating the web page comprises selecting the values from the database based on the type of device requesting the web page.

3. The method of claim 2 wherein the device is a cellular phone or a personal computer.

4. The method of claim 1 further comprising inserting one or more tags into the web page, and wherein the updating of the web page comprises providing a corresponding value from the database for each of the one or more tags.

5. The method of claim 4 wherein the one or more tags are XML code.

6. The method of claim 1 wherein the database is an external server or a database residing on a web server running the web page.

7. The method of claim 1 wherein the web page is running on a web server, and further comprising sending a tracking message to a server other than the web server when the web page is updated using at least one of the values from the database.

8. The method of claim 7 wherein the tracking message is used to track visits to the web page.

9. The method of claim 7 further comprising inserting one or more tags into the web page, and wherein the updating of the web page comprises providing a corresponding value from the database for each of the one or more tags, and wherein the sending of the tracking message is initiated by the substitution of at least one of the tags with one of the values from the database.

10. The method of claim 7 further comprising accessing the web page using a browser, and wherein the sending of the tracking message is not dependent upon the prior receipt of a tracking message from the browser.

11. The method of claim 1 wherein the values comprise one or more of the following: HTML code, graphics code, and text.

12. A method comprising updating a web page using refresh data obtained from a database, where the refresh data has been processed using search optimization prior to the updating of the web page.

13. A system comprising a server executing software to update a web page by refreshing at least a portion of the web page using values obtained from a database, wherein the values have been selected to improve the search visibility of the web page.

14. The system of claim 13 wherein the server is a first server, and further comprising a second server in communication with the first server, wherein the database is stored on the second server.

15. A computer-readable medium having computer-executable instructions for updating a web page by refreshing at least a portion of the web page using values obtained from a database, wherein the values have been selected to improve the search visibility of the web page.

16. A method to improve the search visibility of a web page, comprising:
receiving a request from a device for a web page at a first location; and
responding to the request by sending a web page at a second location to the device, wherein the web page at the second location corresponds to the web page at the first location and further comprises content to improve the search visibility of the web page at the first location.

17. The method of claim 16 wherein the content comprises meta data.

18. The method of claim 16 further comprising periodically updating the content.

19. The method of claim 16 wherein the first location is on a first server and the second location is on a second server.

20. The method of claim 16 wherein the web page at the second location corresponds to the web page at the first location by having at least a portion of the user-visible content on each web page be substantially similar.

21. A method to improve the search visibility of a web page, comprising:
receiving a page request for a web page at a first location;
storing search-optimized content, for each of a plurality of different web pages, at a second location; and
if the second location points to search-optimized content for the web page at the first location, responding to the page request by sending a web page from the second location.

22. The method of claim 21 wherein the first location and the second location are URLs pointing to memory and/or a file system located on one or more web servers.

23. The method of claim 21 further comprising, if the second location does not point to search-optimized content for the web page at the first location, responding to the page request by sending the web page at the first location.
